(19) United States
(12) Patent Application Publication
(10) Pub. No.: US 2021/0117476 A1
(43) Pub. Date: Apr. 22, 2021

(54) METHOD AND APPARATUS FOR SELECTING KEY INFORMATION FOR EACH GROUP IN GRAPH DATA

(71) Applicant: Korea Internet & Security Agency, Jeollanam-do (KR)

(72) Inventors: Seul Gi Lee, Jeollanam-do (KR); Sam Shin Shin, Jeollanam-do (KR); Byung Ik Kim, Jeollanam-do (KR); Soon Tai Park, Jeollanam-do (KR); Kyeong Han Kim, Jeollanam-do (KR); Yeon Seob Song, Jeollanam-do (KR)

(73) Assignee: Korea Internet & Security Agency, Jeollanam-do (KR)

(21) Appl. No.: 16/698,770

(22) Filed: Nov. 27, 2019

(30) Foreign Application Priority Data
Oct. 16, 2019 (KR) 10-2019-0128529

(51) Int. Cl. G06F 16/906; G06F 16/22

(52) U.S. Cl. CPC G06F 16/906; G06F 16/2264

(57) ABSTRACT

Provided are a method and apparatus for selecting key information of each group in grouped graph data. According to embodiments, key information of each group is selected using a term frequency-inverse document frequency (TF-IDF) value obtained for each node belonging to each group by using a TD-IDF algorithm for obtaining the importance of each term or keyword in a document.

This application claims the benefit of Korean Patent Application No. 10-2019-0128529, filed on Oct. 16, 2019, in the Korean Intellectual Property Office, the disclosure of which is incorporated herein by reference in its entirety.

### BACKGROUND

### Field

The present disclosure relates to a method of selecting key information of each group in graph-structured data composed nodes and edges between the nodes, and an apparatus for implementing the method.

### Description of the Related Art

A graph as a data structure denotes data composed of nodes and edges connecting the nodes. As the size of graph data increases, various algorithms for grouping (or clustering) the graph data are provided to grasp information by grouping the information.

However, the data size may increase to the extent that it is not even easy to intuitively grasp the amount of information included in each group configured according to a grouping algorithm. Therefore, it may be helpful to provide a technology for automatically selecting important information, which corresponds to key information, from information belonging to a group by considering the relationship between each node and edge constituting graph data.

### SUMMARY

Aspects of the present disclosure provide a method of supporting easy recognition of key data among data belonging to each group by selecting key information of each group in graph data using automated logic and providing information about a specific group together with the selected key information, and an apparatus or system for implementing the method.

Aspects of the present disclosure also provide a method of selecting key information of each group in graph data using automated logic by reflecting the connection relationship between nodes, and an apparatus or system for reflecting the method.

Aspects of the present disclosure also provide a method of selecting key information of each group in graph data using automated logic by reflecting the similarity between nodes, and an apparatus or system for reflecting the method.

Aspects of the present disclosure also provide a method of suppressing an increase in operation time due to an increase in the size of graph data by adjusting the level of connection relationship information between nodes to be considered according to the size of the graph data, and an apparatus or system for reflecting the method.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

According to an aspect of the present disclosure, there is provided a method of selecting key information, the method being performed by a computing device and comprising obtaining source information, which is graph-structured information, and grouping information reflecting the result of clustering the source information, and selecting one or more pieces of key information of each group g according to the grouping information from nodes n belonging to the group g by using a term frequency-inverse document frequency (TF-IDF)(g, n) value given to each node n of the group g. The TF-IDF(g, n) value may be a value obtained as a result of inputting a node n to a TF-IDF algorithm as a concept corresponding to a term t and inputting a group g to the TF-IDF algorithm as a concept corresponding to a document d.

According to an embodiment, the source information may be cyber threat intelligence information, each group according to the grouping information comprises nodes related to an infringement incident, each node represents an infringement resource, and an edge between the nodes represents the connection relationship between the infringement resources.

According to an embodiment, the selecting of the pieces of key information may comprise selecting one or more pieces of key information of each group g according to the grouping information from nodes n and edges e belonging to the group g by using a TF-IDF(g, n) value or a TF-IDF(g, e) value given to each node n and each edge e of the group g, wherein the TF-IDF(g, e) value may be a value obtained as a result of inputting an edge e to a TF-IDF algorithm as a concept corresponding to a term t and inputting a group g to the TF-IDF algorithm as a concept corresponding to a document d. The edge e may be regarded as belonging to a group g based on all of two nodes connected by the edge e belong to the group g. The edge e also may be regarded as belonging to a group g based on one of two nodes connected by the edge e belongs to the group g.

According to an embodiment, the selecting of the pieces of key information may comprise selecting one or more pieces of key information of each group g according to the grouping information from nodes n and partial graphs s belonging to the group g by using a TF-IDF(g, n) value or a TF-IDF(g, s) value given to each node n and each partial graph s of the group g. The partial graphs s may constitute the source information and each may be composed of two or more element nodes and an element edge connecting the element nodes, and the TF-IDF(g, s) value may be a value obtained as a result of inputting a partial graph s to a TF-IDF algorithm as a concept corresponding to a term t and inputting a group g to the TF-IDF algorithm as a concept corresponding to a document d. Each of the partial graphs s may comprise two element nodes and an element edge connecting the element nodes. Each of the partial graphs s may also comprise three element nodes and element edges connecting the element nodes. Each of the partial graphs s may comprise m element nodes and element edges connecting the element nodes, wherein m may be a natural number of 2 or more and is a value automatically determined based on data size of the source information.

According to an embodiment, the obtaining of the information may comprise further obtaining similarity information between nodes of the source information, and the selecting of the pieces of key information may comprise adjusting a TF(g, n) value indicating whether each node n is included in each group g by reflecting the similarity information between the nodes n and generating the TF-IDF(g, n) value by using the adjusted TF(g, n) value. The adjusting of the TF(g, n) value may comprise adjusting the TF(g, n) value by adding similarity values between node n and another nodes in group g to the existing TF(g, n) value. The adjusting of the TF(g, n) value may comprise obtaining M1×M2(g, n) as the adjusted TF(g, n) value, wherein a matrix M1 may be a two-dimensional (2D) matrix which has nodes disposed as a first axis and groups disposed as a second axis and whose matrix values are TF(g, n) values, and a matrix M2 may be a 2D matrix which has nodes disposed as a first axis and nodes disposed as a second axis and whose matrix values are similarity values between the nodes. The generating of the TF-IDF(g, n) value by using the adjusted TF(g, n) value may comprise generating the TF-IDF(g, n) value by using a DF(n) value, which is obtained as a result of rounding down each adjusted TF(g, n) value and then adding the rounded down TF(g, n) values for all groups, and the adjusted TF(g, n) value. The selecting of the pieces of key information may comprise, adjusting a TF(g, s) value indicating whether each partial graph s is included in each group g by using a ratio of the TF(g, n) value after being adjusted and the TF(g, n) value before being adjusted and generating the TF-IDF(g, s) value by using the adjusted TF(g, s) value. The adjusting of the TF(g, s) value by using the ratio of the TF(g, n) value after being adjusted and the TF(g, n) value before being adjusted may comprise increasing a TF(g1, s) value by a maximum rate among rates of increase of TF(g1, n) values of nodes belonging to group g1 through the adjustment. The generating of the TF-IDF (g, s) value by using the adjusted TF(g, s) value may comprise generating the TF-IDF(g, s) value by using a DF(s) value, which is obtained as a result of rounding down each adjusted TF(g, s) value and then adding the rounded down TF(g, s) values for all groups, and the adjusted TF(g, s) value.

According to other aspect of the present disclosure, there is provided a method of selecting key information, the method comprises obtaining source information, which is graph-structured information composed of nodes and edges between the nodes, and grouping information reflecting the result of clustering the source information, selecting one or more pieces of key information of each group g according to the grouping information from nodes n and edges e belonging to the group g by using a TF-IDF(g, n) value given to each node n or a TF-IDF(g, e) value given to each edge e of the group g and receiving an information request for a first group among the groups from a client and sending response information, which comprises the key information of the first group, to the client based on the number of elements of the first group exceeding a reference value.

According to another aspect of the present disclosure, an apparatus for selecting key information is provided. The apparatus comprises a communication interface, a memory and a processor which executes a computer program loaded into the memory. The computer program may comprise instructions for obtaining source information, which is graph-structured information, and grouping information reflecting the result of clustering the source information, instructions for selecting one or more pieces of key information of each group g according to the grouping information from nodes n belonging to the group g by using a TF-IDF(g, n) value given to each node n of the group g and instructions for receiving an information request for a first group among the groups from a client through the communication interface and sending response information, which comprises the key information of the first group, to the client through the communication interface.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates the configuration of a graph data query system according to an embodiment;

FIGS. 2A through 2C are diagrams for explaining data in a graph format and the configuration of each group created as a result of grouping the data, which are referred to in the process of describing some embodiments;

FIGS. 3 and 4 are diagrams for explaining a process of selecting key information of each group using a term frequency-inverse document frequency (TF-IDF) algorithm in some embodiments;

FIGS. 5A through 6B are diagrams for explaining a case where partial graphs are further included as candidates to be selected as key information in some embodiments;

FIGS. 7A through 12 are diagrams for explaining a process of selecting key information of each group by reflecting the similarity between nodes in some embodiments;

FIG. 13 is a flowchart illustrating a method of selecting key information according to an embodiment; and

FIG. 14 illustrates the configuration of an example computing device that can implement apparatuses/systems according to various embodiments.

### DETAILED DESCRIPTION

Advantages and features of the presently disclosed technology and methods of accomplishing the same may be understood more readily by reference to the following detailed description of embodiments and the accompanying drawings. The presently disclosed technology may, however, be embodied in many different forms and should not be construed as being limited to the embodiments set forth herein. Rather, these embodiments are provided so that this disclosure will be thorough and complete and will fully convey the concept of the presently disclosed technology to those skilled in the art, and the presently disclosed technology will be defined by the appended claims Like reference numerals refer to like elements throughout the specification.

The terminology used herein is for the purpose of describing particular embodiments and is not intended to be limiting of the presently disclosed technology. As used herein, the singular forms “a”, “an” and “the” are intended to include the plural forms as well, unless the context clearly indicates otherwise. It will be further understood that the terms “comprises” and/or “comprising,” as used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present disclosure will be described in detail with reference to the attached drawings.

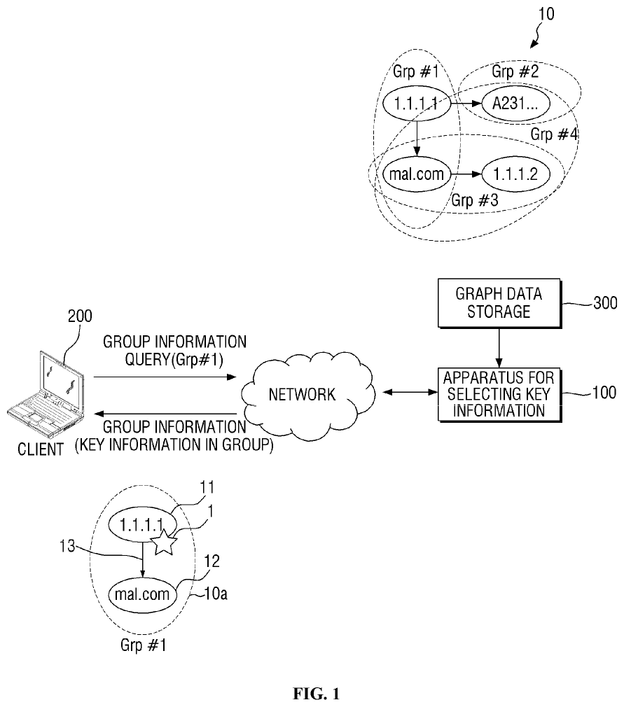

First, the configuration and operation of a graph data query system according to an embodiment will be described with reference to FIG. 1.

The graph data query system according to the current embodiment includes an apparatus 100 for selecting key information. The key information selecting apparatus 100 obtains graph data 10 and grouping information of the graph data 10, analyzes the obtained information, and selects key information of each group. The key information selecting apparatus 100 may receive the graph data 10 and the grouping information of the graph data 10 from a graph data storage 300 which is a computing device separate from the key information selecting apparatus 100. Alternatively, the graph data 10 and the grouping information of the graph data 10 may be stored in a storage of the key information selecting apparatus 100.

A client 200 sends a query for the graph data 10 to the key information selecting apparatus 100. The query may include a condition for data desired to be obtained. The condition may be, for example, a request for information about any one of a plurality of groups formed in the graph data 10. The key information selecting apparatus 100 receives the query and generates a response to the query. The information about the requested group may be included in the response.

The information about the requested group may include information about all nodes and all edges included in the requested group. For example, based on information about group 1 Grp #1 among four groups in the graph data 10 illustrated in FIG. 1 requested through the query, information about two nodes 11 and 12 included in group 1 (10a) and one edge 13 connecting the two nodes 11 and 12 may be included in the response to the query.

In the present specification, ‘information’ of a specific group refers to nodes, edges and partial graphs belonging to the specific group among nodes, edges and partial graphs of the graph data 10. In addition, ‘key information’ of the specific group refers to information automatically selected from the ‘information’ of the specific group according to a predetermined criterion.

Further, based on generating a response to the query, the key information selecting apparatus 100 may select key information of the requested group and include the key information in the response. In FIG. 1, “1.1.1.1” (11) is selected as key information 1. The key information may be some of the nodes, edges and partial graphs included in the requested group. A partial graph is composed of some of all nodes and edges belonging to a full graph.

The key information selecting apparatus 100 selects key information of each group in the graph data 10 by executing a key information selecting program implemented based on a term frequency-inverse document frequency (TF-IDF) algorithm. The operation of selecting key information of each group using the key information selecting apparatus 100 will be briefly described below.

The key information selecting apparatus 100 selects some of the nodes, edges and partial graphs belonging to each group in the graph data 10 as key information based on the TF-IDF algorithm.

The TF-IDF algorithm is an algorithm for assigning a weight, which reflects importance, to each term included in a document. A TF-IDF value output by the TF-IDF algorithm is a value calculated based on the product of a TF value and an IDF value. Based on the TF-IDF value of a first term being high among terms included in a first document, it means that the first term frequently appears in the first document although it does not frequently appear in other documents.

The key information selecting apparatus 100 executes a TF-IDF algorithm modified from the existing TF-IDF algorithm to be suitable for selecting key information of each group in graph data. In the present specification, a value output by the execution of the ‘modified TF-IDF algorithm’ will be referred to as a TF-IDF value.

The key information selecting apparatus 100 inputs each group of the graph data 10 to the TF-IDF algorithm as a concept corresponding to a document din the existing TF-IDF algorithm and inputs each node belonging to each group of the graph data 10 to the TF-IDF algorithm as a concept corresponding to a term tin the existing TF-IDF algorithm.

In some embodiments, the key information selecting apparatus 100 may further input at least one of each edge and each partial graph belonging to each group to the TF-IDF algorithm as a concept corresponding to a term tin the existing TF-IDF algorithm.

For example, based on a first group including a first node, a second node and a first edge connecting the first node and the second node, the key information selecting apparatus 100 may calculate TF-IDF values of the first node and the second node for the first group and, in some embodiments, may additionally calculate a TF-IDF value of the first edge for the first group in order to select key information from information of the first group. Of the information belonging to the first group, information having a high TF-IDF value for the first group is information not included in groups other than the first group or information included in a few other groups. Therefore, the key information selecting apparatus 100 may select information having a largest value among the TF-IDF values obtained for the first group as key information. Accordingly, information unique to the first group may be selected in an automated manner.

The key information selecting apparatus 100 selects key information based on the technical spirit of the existing TF-IDF algorithm. The existing TF-IDF algorithm is a methodology used to evaluate the importance of each term in a document, but is not a methodology applied to grouped graph data and used to select key information from information in each group. In addition, the existing field of application in which the importance of each term in a document is evaluated is completely different from the field of application according to embodiments of the present disclosure. Also, the existing TF-IDF algorithm is not an algorithm that can be easily considered for application as a technology for selecting key information from information of graph data belonging to a specific group. This is because the existing TF-IDF algorithm can be considered for application basically in a situation where each evaluation target can have various TF values. On the other hand, in the field of application according to the embodiments, whether each node is included in a specific group or not varies, but each node cannot be included multiple times in the specific group. Therefore, the TF value of evaluation target information is 0 or 1. Nonetheless, the embodiments provide an optimal technology for selecting key information from information of graph data based on the TF-IDF algorithm.

The key information selecting apparatus 100 may select key information of each group in any data in a graph format regardless of the content of the data. For example, the key information selecting apparatus 100 obtains graph data as cyber threat intelligence information in which each group according to grouping information includes nodes related to an infringement incident, each node represents an infringement resource, and an edge between the nodes represents the connection relationship between the infringement resources; selects key information of each group; and generates and sends a response, which includes the key information automatically selected from information belonging to a specific group, in response to a query for the specific group so that an infringement resource unique to a specific infringement incident among infringement resources related to the specific infringement incident can be easily recognized.

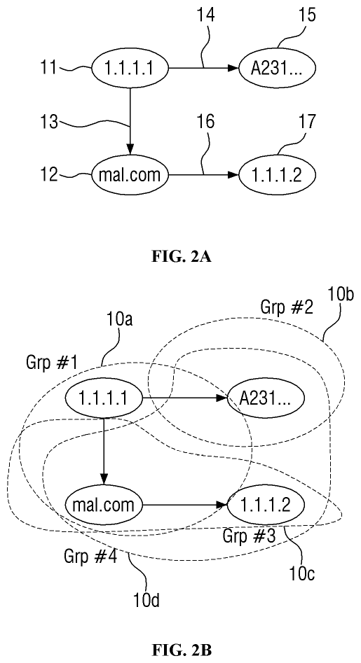

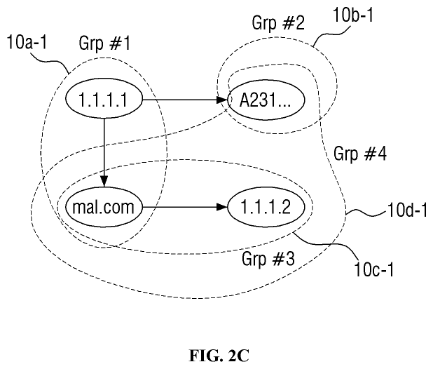

A method of selecting key information according to an embodiment will now be described in more detail with reference to FIGS. 2A through 13. The method according to the current embodiment is executed by a computing device. For example, the computing device may be the key information selecting apparatus 100 described above with reference to FIG. 1. However, the method according to the current embodiment can be performed using any computing device including a calculation unit and a storage unit. For example, the method according to the current embodiment may be executed by a personal computing device such as a notebook computer, a desktop computer, a tablet computer, or a smartphone. Based on the subject of each operation constituting the method according to the current embodiment not being specified in the following description, it should be understood that the subject is the computing device. In addition, it should be noted that not all operations constituting the method according to the current embodiment are executed by one computing device, and some operations constituting the method according to the current embodiment may be executed by a computing device different from a computing device executing other operations. As already described, the method according to the current embodiment may be executed on any data in a graphic format regardless of the content of the data. For example, the graph data may be the cyber threat intelligence data, and each group may represent a cyber infringement incident.

Data in a graph format and the configuration of each group created as a result of grouping the data, which are referred to in the process of describing the current embodiment, will now be described with reference to FIGS. 2A through 2C.

FIG. 2A illustrates exemplary and simple graph data composed of four nodes 11, 12, 15 and 17 and three edges 13, 14 and 16. In some embodiments, simple graph data may not be grouped (or clustered). However, it is assumed for the sake of description that the graph data of FIG. 2A has been grouped. That is, a computing device that executes the method according to the current embodiment may obtain graph data and grouping information of the graph data.

The grouping information includes information indicating nodes belonging to each group. Here, each group g may be determined to include an edge e based on two nodes n1 and n2 connected by the edge e all being included in the group g (first method), may be determined to include the edge e based one or more of the two nodes n1 and n2 connected by the edge e being included in the group g (second method), or may be determined to include the edge e based on a weight of the edge e exceeding a reference value and one of the two nodes n1 and n2 connected by the edge e being included in the group g.

Embodiments will be described below based on the premise that group 1 Grp #1 (10a) includes a node “1.1.1.1” (11) and a node “mal.com” (12), group 2 Grp #2 (10b) includes a node “A231 . . . ” (15), group 3 Grp #3 (10c) includes the node “mal.com” (12) and a node “1.1.1.2” (17), and group 4 Grp #4 (10d) includes the node “mal.com” (12), the node “A231 . . . ” (15) and the node “1.1.1.2” (17).

Here, according to the first method described above, as illustrated in FIG. 2C, group 1 Grp #1 (10a) includes an edge 13 between the node “1.1.1.1” (11) and the node “mal.com” (12), group 2 Grp #2 (10b) does not include an edge, and each of group 3 Grp #3 (10c) and group 4 Grp #4 (10d) includes an edge 16 between the node “mal.com” (12) and the node “1.1.1.2” (17).

Alternatively, according to the second method described above, as illustrated in FIG. 2B, group 1 Grp #1 (10a) includes two edges 14 and 16 in addition to the edge 13 between the node “1.1.1.1” (11) and the node “mal.com” (12), group 2 Grp #2 (10b) includes the edge 14, group 3 Grp #3 (10c) includes the edge 13 in addition to the edge 16 between the node “mal.com” (12) and the node “1.1.1.2” (17), and group 4 Grp #4 (10d) includes two edges 13 and 14 in addition to the edge 16 between the node “mal.com” (12) and the node “1.1.1.2” (17).

As already described, in some embodiments, information of a specific group may include nodes and edges. This means that an edge can be selected as key information of the specific group. Based on a method of including an edge in each group is the second method, more edges are included in the specific group compared to the method of including an edge in each group, which may be referred to as the first method. Therefore, in the case of graph data in which edges are as highly valuable as information as nodes, edges belonging to each group will be determined according to the second method. Conversely, in the case of graph data in which edges are not valuable as information, edges belonging to each group will be determined according to the first method. Since the number of edges belonging to each group is reduced based on the first method is used, computational resources can be saved that much.

In some embodiments, should source information be the cyber threat intelligence information, the method of including an edge in each group may be determined to be the first method. This is because should the source information be the cyber threat intelligence information, information included in the specific group may contain noise, based on an edge connecting two nodes being included in a specific group, even though one of the two nodes is included in the specific group.

In some embodiments, the method of including an edge in each group may be automatically determined to be any one of the first method and the second method (third method). For example, in order to save computational resources, the method of including an edge in each group may be automatically determined to be the second method based on an indicator value (NUM_EDGE/NUM_NODE) calculated using the total number (NUM_EDGE) of edges included in graph data and the total number (NUM_NODE) of nodes included in the graph data exceeding a reference value and may be automatically determined to be the first method based on the indicator value (NUM_EDGE/NUM_NODE) being less than the reference value.

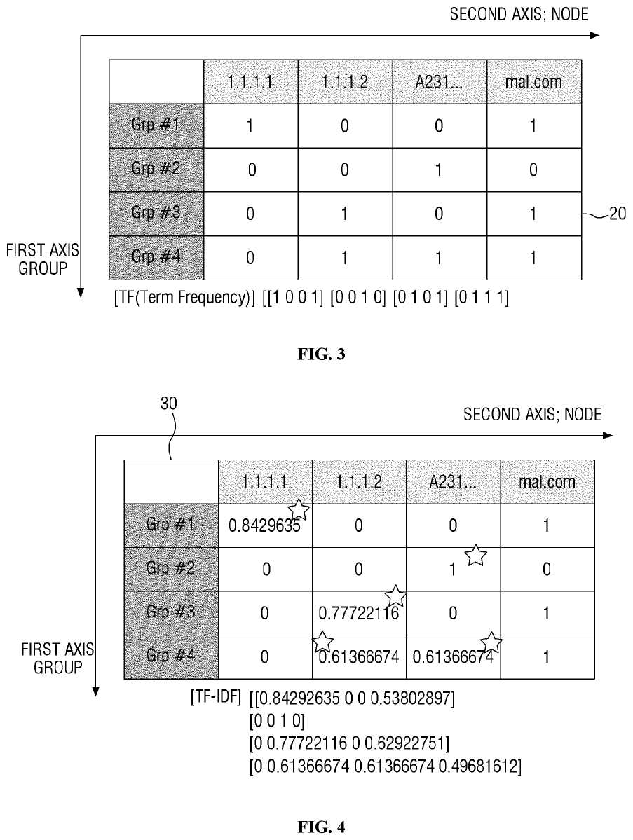

A method of selecting key information of each group from nodes included in each group in some embodiments will now be described with reference to FIGS. 3 and 4. FIGS. 3 and 4 are diagrams for explaining a method of selecting key information of each group in a situation where the graph data and the grouping information of the graph data of FIGS. 2A through 2C are obtained.

FIG. 3 illustrates a two-dimensional (2D) matrix TF[G][N] (20) representing the TF value of each node. Here, N indicates the total number of nodes in graph data, and G indicates the total number of groups in the graph data. The TF value TF[g][n] may be ‘1’ based on node n belonging to group g and may be ‘0’ based on node n not belonging to group g. In the matrix TF[G][N] (20) of FIG. 3, the value of DF(n), that is, the number of times each node belongs to each group is as follows.

DF(1.1.1.1)=1+0+0+0=1

DF(1.1.1.2)=0+0+1+1=2

DF(A231 . . . )=0+1+0+1=2

DF(mal.com)=1+0+1+1=3

Next, the IDF value of node n is given by Equation 1 below.

$$IDF ( n ) = ln \frac{1 + G}{1 + DF ( n )} + 1 \\ ( G is the total number of groups ) . \qquad ( 1 )$$

The IDF value of each node according to Equation 1 is as follows.

IDF(1.1.1.1)=1n[(1+4)/(1+1)]+1=1.91629073187

IDF(1.1.1.2)=ln[(1+4)/(1+2)]+1=1.51082562376

IDF(A231 . . . )=ln[(1+4)/(1+2)]+1=1.51082562376

IDF(mal.com)=ln[(1+4)/(1+3)]+1=1.22314355131

Next, the TF-IDF value of node n for group g is given by Equation 2 below.

TF−IDF(g,n)=TF(g,n)×IDF(n) (2).

In some embodiments, based on the TF-IDF value of node n for group g being calculated, a feature vector of each group may be normalized by applying L2 normalization to the result of Equation 2. FIG. 4 illustrates a 2D matrix TF-IDF[G][N] (30) representing the result of L2-normalizing the TF-IDF value of each node for each group.

Next, key information of each group is selected using the TF-IDF value of node n for group g. For example, a node having a largest TF-IDF value in each group may be selected as the key information. In FIG. 4, a node having the largest TF-IDF value in each group is selected as the key information. Asterisks in FIG. 4 indicate the key information.

The embodiments in which key information is selected from nodes belonging to each group have been described above. According to some embodiments, key information may also be selected from nodes and edges belonging to each group. Here, whether each edge is included in each group may be determined using any one of the above-described methods of including an edge in each group (any one of the first through third methods). The DF value, IDF value and TF-IDF value of each edge may be calculated in the same way as the DF value, IDF value and TF-IDF value of each node.

Compared with the embodiments of selecting key information from nodes belonging to each group, the embodiments of selecting key information from nodes and edges belonging to each group provide an additional effect of selecting key information by reflecting the connection relationship between nodes.

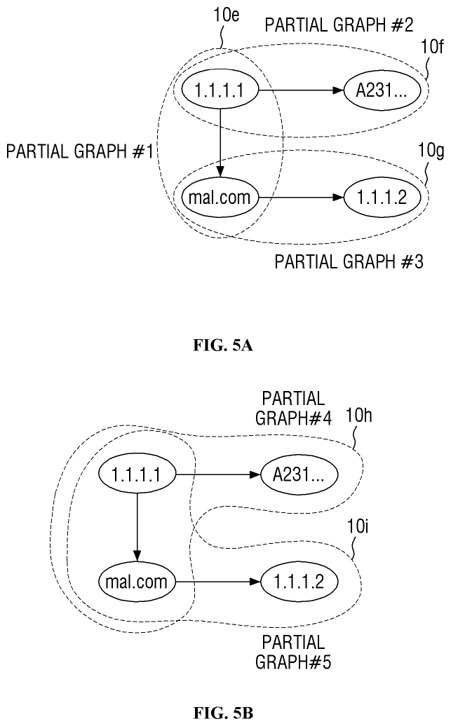

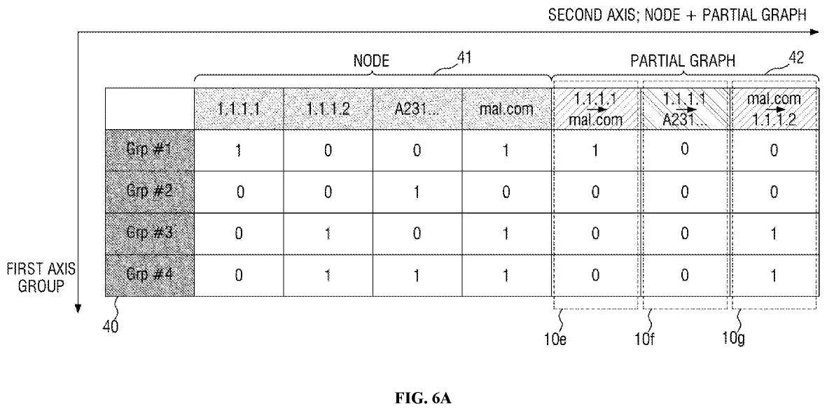

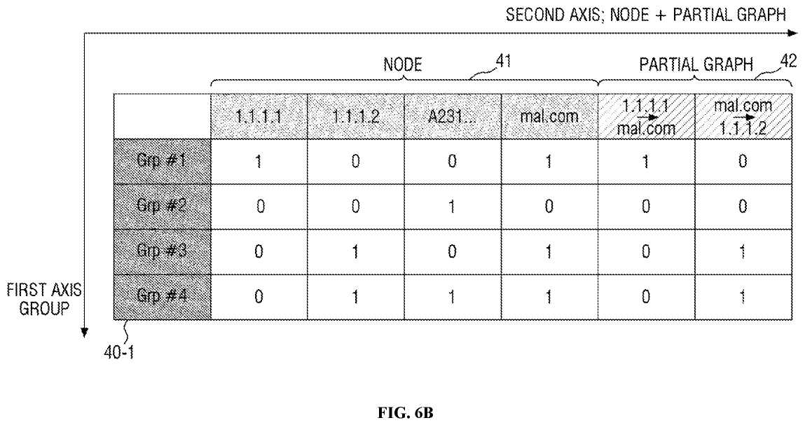

In some embodiments, key information may also be selected from nodes and partial graphs belonging to each group in order to more accurately reflect the connection relationship. This will now be described with reference to FIGS. 5A through 6B.

As already described, a partial graph is composed of some of nodes and edges of a full graph. The partial graph used herein includes two or more nodes, and the nodes are connected to each other by at least one edge. That is, the partial graph used herein includes two or more nodes as a connected graph.

In an embodiment, the partial graph may be composed of two nodes and one edge connecting the two nodes. This partial graph is a minimum partial graph that cannot be divided any more. Even a complicated graph can be represented as a union of a plurality of partial graphs, each composed of two nodes and one edge. The partial graph composed of two nodes and one edge will hereinafter be referred to as a minimum partial graph. The minimum partial graph may be understood as bi-gram information in that it is information representing two nodes having a direct connection relationship.

FIG. 5A illustrates three partial graphs 10e, 10f and 10g included in the full graph of FIG. 2A. In the current embodiment, the key information may be selected from nodes and minimum partial graphs included in each group.

In an embodiment, the partial graph may be composed of a first node, a second node, a third node, a first edge connecting the second node and the first node, and a second edge connecting the second node and the third node. That is, the partial graph may be composed of two edges connecting one node to two different nodes and three nodes. The partial graph may be understood as 3-gram information in that it is information about the first node and the third node having a direct connection relationship with the second node, that is, information representing three nodes sequentially connected to each other.

FIG. 5B illustrates two 3-gram partial graphs 10h and 10i included in the full graph of FIG. 2A. In the current embodiment, the key information may be selected from nodes and 3-gram partial graphs included in each group.

In an embodiment, the partial graph may represent N-gram information (where N is a natural number of 4 or more).

In an embodiment, in the N-gram information represented by the partial graph, appropriate ‘N’ may be automatically determined in consideration of full graph data. For example, a smallest value may be determined as the value of ‘N’ in the N-gram information as long as the number of partial graphs extracted from the full graph data does not exceed a reference value. For example, based on the size of the full graph data not being large or the reference value being set to a sufficiently high value, the value of ‘N’ in the N-gram information may be determined to be ‘2.’ For ease of understanding, an embodiment in which key information is selected from nodes and partial graphs representing bi-gram information in each group will be described.

FIG. 6A illustrates a 2D matrix TF[N+S][G] (40) in which all nodes 41 of graph data and all partial graphs (bi-gram) 42 of the graph data are disposed on a first axis, and groups are disposed on a second axis. Here, ‘S’ indicates the total number of partial graphs. As described above with reference to FIG. 5A, a total of three bi-gram partial graphs 10e, 10f and 10g are included in the full graph data. However, one 10f of the three partial graphs 103, 10f and 10g does not belong to any group as shown in the TF matrix 40 of FIG. 6A. Therefore, the partial graph 10f may be deleted as illustrated in FIG. 6B.

The DF value of each node 41 and the DF value of each partial graph 42 may be calculated based on a TF matrix 40-1 of FIG. 6B. After IDF values are calculated according to Equation 1, TF-IDF values may be calculated according to Equation 2. Then, key information may be selected from the nodes 41 and the partial graphs 42 in each group.

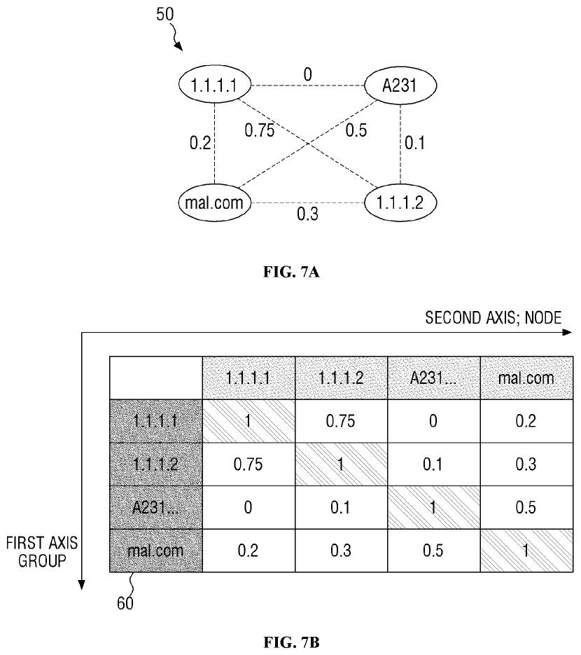

However, even the embodiments described above fail to reflect the similarity between nodes based on selecting key information. Therefore, in some embodiments, key information of each group may be selected by further reflecting the similarity between nodes. An embodiment in which key information of each group is selected by further reflecting the similarity between nodes will now be described with reference to FIGS. 7A through 12.

In the embodiment to be described below, a similarity relationship 50 between nodes in FIG. 7A is assumed. A matrix 60 of FIG. 7B in which both a first axis and a second axis indicate nodes represents the similarity relationship 50 between nodes in FIG. 7A. The similarity relationship between nodes has a real number value of 0 to 1.

In some embodiments, the TF value of each node in each group is adjusted by reflecting the similarity relationship between nodes.

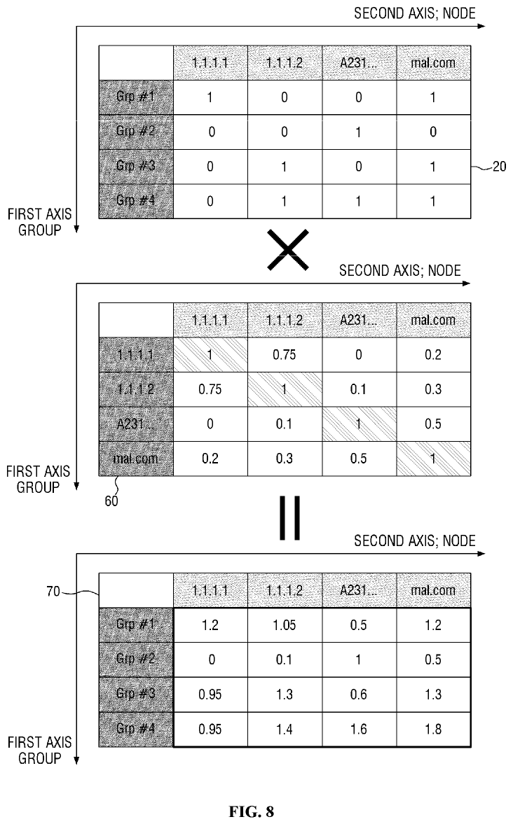

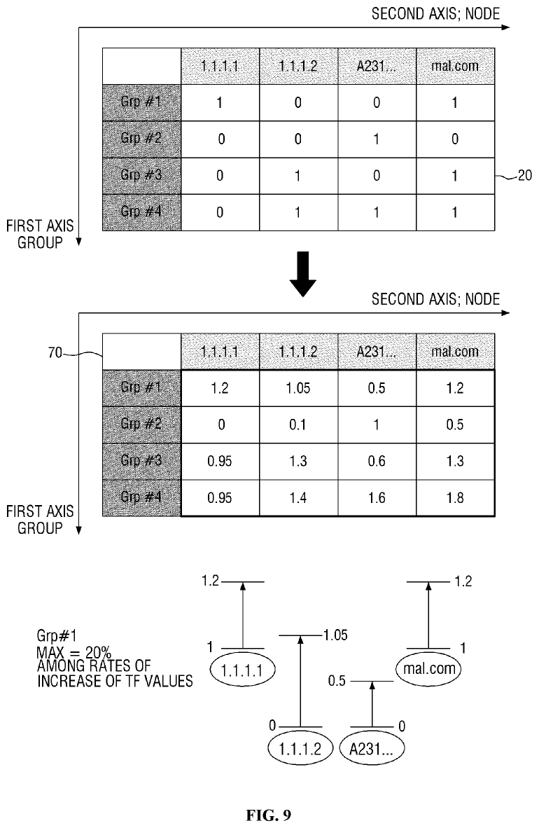

In order to adjust the TF value of each node, M1×M2[g, n] may be obtained as the adjusted TF(g, n) value. A matrix M1 (60) is a 2D matrix which has nodes disposed as a first axis and nodes disposed as a second axis and whose matrix values are similarity values between the nodes. A matrix M2 (20) is a 2D matrix which has nodes disposed on a first axis and groups disposed on a second axis and whose matrix values are TF(g, n) values. In FIG. 8, a matrix M1×M2 (70) obtained by multiplying the matrix M1 (60) and the matrix M2 (20) is illustrated. Each matrix value of the matrix M1×M2 (70) may be understood as the TF value adjusted by reflecting the similarity between nodes.

In order to adjust the TF value of each node, according to an embodiment, a similarity value between another node and node n included in group g may be added to the existing TF(g, n) value, thereby adjusting the TF(g, n) value. This is a conclusion derived through an internal operation performed in the process of multiplying the matrix M1 (60) and the matrix M2 (20). For example, the adjusted TF value “1.2” of the node “1.1.1.1” for group 1 Grp #1 is a value obtained by adding a similarity value “1” between another node “mal.com” and the node “1.1.1.1” included in group 1 to the original TF value “1” of the node “1.1.1.1.”

FIG. 9 illustrates the matrix 20 including the original TF value of each node and the matrix 70 including the adjusted TF value of each node. In the case of group 1 Grp #1, the TF value of the node “1.1.1.1” was adjusted from 1 to 1.2, the TF value of the node “1.1.1.2” was adjusted from 0 to 1.05, the TF value of the node “A231 . . . ” was adjusted from 0 to 0.5, and the TF value of the node “mal.com” was adjusted from 1 to 1.2. That is, the adjustment of the TF value is performed in a direction to increase the TF value.

Increasing the TF value by reflecting the similarity value between nodes may also be performed on a partial graph that can be selected as key information together with a node. In addition, a rate of increase of the TF value of the partial graph may match with a maximum rate among rates of increase of the TF values of the nodes. This is because the partial graph including a plurality of nodes and an edge between the nodes contains more information than each node. That is, since the partial graph has at least as much importance as each node, the TF(g, s) value which is the TF value of partial graph s for group g may be increased by a maximum rate among rates of increase of the TF(g, n) values of nodes belonging to group g through the above adjustment.

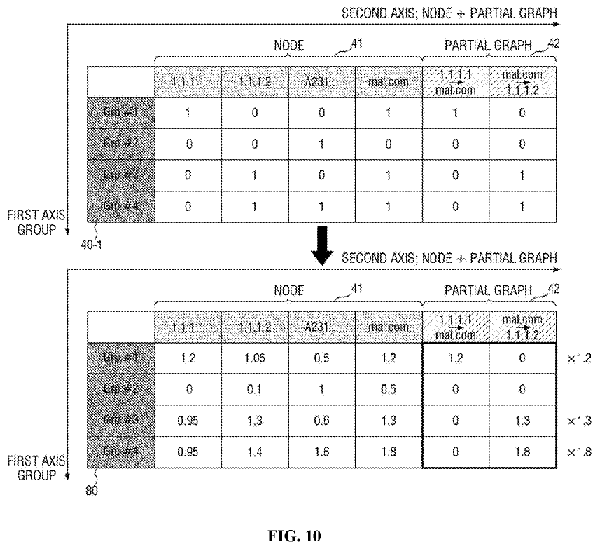

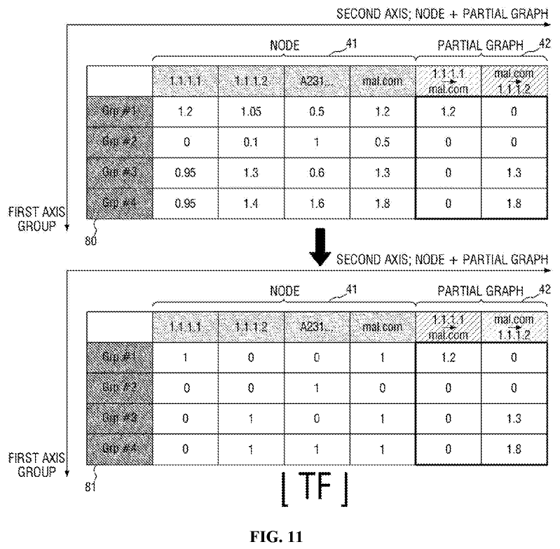

In the example of FIG. 9, based on a TF value of 0 being excluded from TF values whose rates of increase are to be calculated because a rate of increase cannot be calculated based on the original TF value of a node for group 1 being 0, a rate of increase of the TF value of the node “1.1.1.1” and a rate of increase of the TF value of the node “mal.com” are all 20%. Therefore, as illustrated in FIG. 10, the TF values of all partial graphs 42 for group 1 are also increased by 20%. For the same reason as group 1, the TF values of all partial graphs 42 for group 3 are increased by 30%, and the TF values of all partial graphs 42 for group 4 are increased by 80%. The result is a matrix TF[G][N+S′] (80) including the adjusted TF value of each node and the adjusted TF value of each partial graph. Here, G is the total number of groups, N is the total number of nodes, and S′ is a number obtained by subtracting the number of partial graphs not belonging to any group from the total number of partial graphs.

However, an adjusted TF value is a value including a decimal point, which does not correspond to the definition of a TF value used in the current embodiment to indicate whether each node or partial graph is included in a specific group. Therefore, the TF-IDF value of each node and each partial graph may be calculated after the TF value is rounded down. FIG. 11 illustrates a matrix TF[G][N+S′] (81) obtained after TF values are rounded down.

In the matrix TF[G][N+S′] (81) of FIG. 11, the value of DF(n), that is, the number of times each node belongs to each group and the value of DF(s), that is, the number of times each partial graph belongs to each group are obtained as follows.

DF(1.1.1.1)=1+0+0+0=1

DF(1.1.1.2)=1+0+1+1=3

DF(A231 . . . )=0+1+0+1=2

DF(mal.com)=1+0+1+1=3

As apparent from the above, the original DF value is the same as the DF value calculated based on the adjusted TF values in the case of other nodes. However, while the original DF value of the node “1.1.1.2” is 2, the DF value calculated based on the adjusted TF values is 3. Therefore, the IDF value of the node “1.1.1.2” becomes different from the original IDF value. Accordingly, this may change the result of selecting key information of each group.

Next, the IDF values of node n and partial graph s are given by Equation 1 presented above.

IDF(1.1.1.1)=ln[(1+4)/(1+1)]+1=1.91629073187 (same as before the similarity between nodes is reflected)

IDF(1.1.1.2)=ln[(1+4)/(1+2)]+1=1.51082562376 (different from before the similarity between nodes is reflected)

IDF(A231 . . . )=ln[(1+4)/(1+2)]+1=1.51082562376 (same as before the similarity between nodes is reflected)

IDF(mal.com)=ln[(1+4)/(1+3)]+1=1.22314355131 (same as before the similarity between nodes is reflected)

IDF(1.1.1.1-->mal.com)=ln[(1+4)/(1+1)]+1=1.91629073187

IDF(mal.com-->1.1.1.2)=ln[(1+4)/(1+1)]+1=1.151082562376

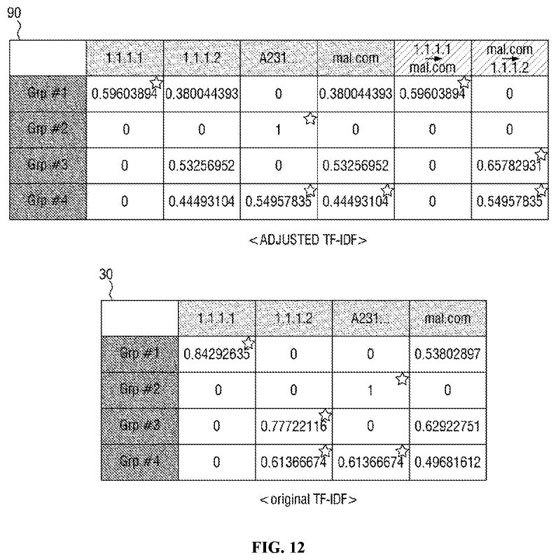

Next, the TF-IDF value of node n for group g is given by Equation 2 presented above. In addition, based on the TF-IDF value of node n for group g being calculated, a feature vector of each group may be normalized by applying L2 normalization to the result of Equation 2 as described above. FIG. 12 illustrates a 2D matrix TF-IDF[G][N+S′] (90) representing the result of L2-normalizing the TF-IDF values of each node and each partial graph for each group.

Next, key information of each group is selected using the TF-IDF values of node n and partial graph s for group g. For example, a node having a largest TF-IDF value in each group may be selected as the key information. In FIG. 12, a node or partial graph having the largest TF-IDF value in each group is selected as the key information. Asterisks in FIG. 12 indicate the key information.

A lower part of FIG. 12 illustrates the result of selecting key information of each group using the TF value of each node for each group in graph data, and an upper part of FIG. 12 illustrates the result of selecting the key information of each group by adjusting or increasing the TF value of each node for each group in the graph data by reflecting the similarity value between the nodes and then increasing the TF value of each partial graph by reflecting this increase of the TF value. According to this, it can be seen that the result of selecting the key information has been changed in groups 1, 3 and 4 as a result of reflecting the similarity value between the nodes and additionally considering the partial graphs as the key information to reflect the connection relationship between the nodes.

That is, according to the embodiments described above, key information of each group in grouped graph data is selected in an automated manner. In particular, since the similarity between nodes and the connection relationship between the nodes are reflected, the accuracy of selecting the key information of each group can be increased.

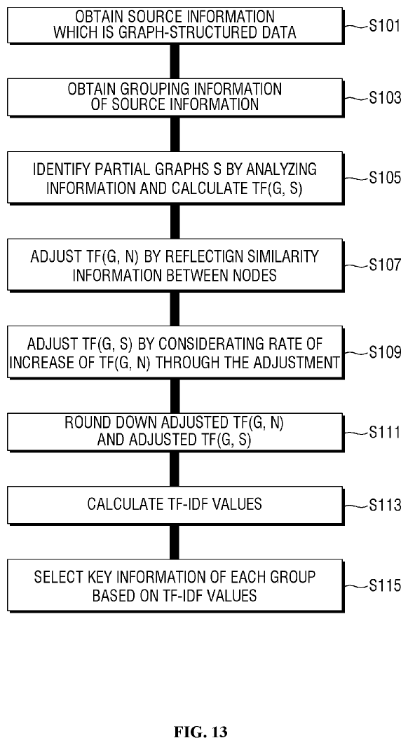

The method of selecting key information described above with reference to FIGS. 2A through 12 will now be summarized with reference to a flowchart of FIG. 13. For ease of understanding, details described above with reference to FIGS. 2A through 12 will not be described again.

In operations S101 and S103, source information which is graph-structured data is obtained, and grouping information of the source information is obtained. Then, one or more pieces of key information of each group g according to the grouping information may be selected from nodes n belonging to the group g by using a TF-IDF (g, n) value given to each node n of the group g. The TF-IDF(g, n) value is a value obtained as a result of inputting a node n to a TF-IDF algorithm as a concept corresponding to a term t and inputting a group g to the TF-IDF algorithm as a concept corresponding to a document d. In some embodiments, the key information selected in the above way may be provided to a client. In some embodiments, some operations may be modified in order to select the key information by further reflecting the connection relationship between the nodes and the similarity between the nodes. This will be described below.

In operation S105, the connection relationship between element information (nodes and edges) of the source information is analyzed to identify partial graphs s, and TF(g, s) which is a TF value of each partial graphs is calculated.

In operation S107, TF(g, n) values are adjusted to increase by reflecting the similarity (a real number of 0 to 1) between the nodes. In addition, in operation S109, the TF(g, s) values are adjusted to increase by reflecting the increase in the TF(g, n) values.

In operation S111, the adjusted TF(g, n) values and the adjusted TF(g, s) values are rounded down to remove values below a decimal point which contradict the definition of the TF values.

In operation S113, TF-IDF values of each node and each partial graph for each group are calculated using the rounded down TF(g, n) values and the rounded down TF(g, s) values. In operation S115, key information of each group is selected based on the calculated TF-IDF values.

The selected key information of each group may be included in group information generated in response to a group information query received from a client and then may be sent to the client. For example, the information sent to the client may include the key information of a requested group together with information about nodes and edges belonging to the requested group. In some embodiments, the key information may not be included in the group information but may be included in the group information based on the number of elements of the requested group exceeding a reference value. The number of elements is a value obtained by adding the number of at least some of the nodes and the number of at least some of edges. Based on the amount of information included in the requested group not being large, it is efficient to immediately provide a response rather than selecting the key information. Therefore, in the current embodiment, it may be understood that the logic of selecting the key information is additionally performed based on it being difficult to rapidly identify the key information because the amount of information included in the requested group is large.

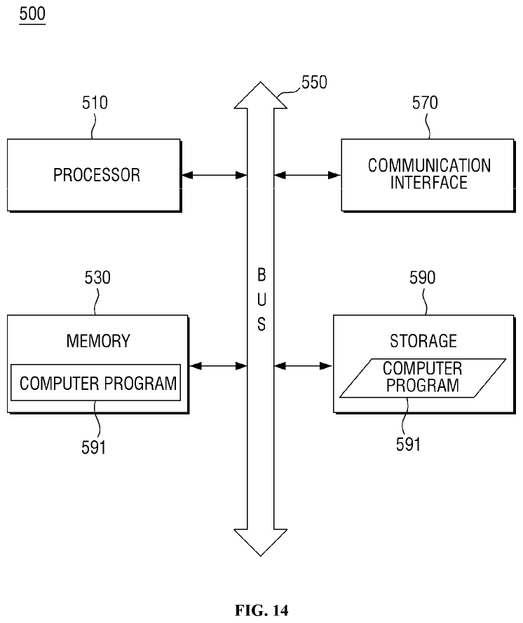

An example computing device 500 that can implement the key information selecting method or the data query method described in the various embodiments will now be described with reference to FIG. 14.

FIG. 14 illustrates the exemplary hardware configuration of the computing device 500.

Referring to FIG. 14, the computing device 500 may include one or more processors 510, a bus 550, a communication interface 570, a memory 530 which loads a computer program 591 to be executed by the processors 510, and a storage 590 which stores the computer program 591. In FIG. 14, the components related to the embodiment are illustrated. Therefore, it will be understood by those of ordinary skill in the art to which the present disclosure pertains that other general-purpose components can be included in addition to the components illustrated in FIG. 14.

The processors 510 control the overall operation of each component of the computing device 500. The processors 510 may include at least one of a central processing unit (CPU), a micro-processor unit (MPU), a micro-controller unit (MCU), a graphics processing unit (GPU), and any form of processor well known in the art to which the present disclosure pertains. In addition, the processors 510 may perform an operation on at least one application or program for executing methods according to embodiments. The computing device 500 may include one or more processors.

The memory 530 stores various data, commands and/or information. The memory 530 may load one or more programs 591 from the storage 590 in order to execute methods/operations according to various embodiments. For example, based on the computer programs 591 loaded into the memory 530, logic (or a module) may be implemented on the memory 530. The memory 530 may be, but is not limited to, a random access memory (RAM).

The bus 550 provides a communication function between the components of the computing device 500. The bus 550 may be implemented as various forms of buses such as an address bus, a data bus and a control bus.

The communication interface 570 supports wired and wireless Internet communication of the computing device 500. The communication interface 570 may also support various communication methods other than Internet communication. To this end, the communication interface 570 may include a communication module well known in the art to which the present disclosure pertains.

The storage 590 may non-temporarily store one or more programs 591. The storage 590 may include a nonvolatile memory such as a read only memory (ROM), an erasable programmable ROM (EPROM), an electrically erasable programmable ROM (EEPROM) or a flash memory, a hard disk, a removable disk, or any form of computer-readable recording medium well known in the art to which the present disclosure pertains.

The computer program 591 may include one or more instructions that implement methods/operations according to various embodiments. Based on the computer program 591 loaded into the memory 530, the processors 510 may perform the methods/operations according to the various embodiments by executing the instructions.

The technical spirit of the present disclosure described above with reference to FIGS. 1 through 14 can be implemented in computer-readable code on a computer-readable medium. The computer-readable recording medium may be, for example, a removable recording medium (a compact disc (CD), a digital versatile disc (DVD), a Blu-ray disc, a universal serial bus (USB) storage device or a portable hard disk) or a fixed recording medium (a ROM, a RAM or a computer-equipped hard disk). The computer program recorded on the computer-readable recording medium may be transmitted to another computing device via a network such as the Internet and installed in the computing device, and thus can be used in the computing device.

The foregoing is illustrative of the presently disclosed technology and is not to be construed as limiting thereof. Although a few embodiments of the presently disclosed technology have been described, those skilled in the art will readily appreciate that many modifications are possible in the embodiments without materially departing from the novel teachings and advantages of the presently disclosed technology. Accordingly, all such modifications are intended to be included within the scope of the presently disclosed technology as defined in the claims. Therefore, it is to be understood that the foregoing is illustrative of the presently disclosed technology and is not to be construed as limited to the specific embodiments disclosed, and that modifications to the disclosed embodiments, as well as other embodiments, are intended to be included within the scope of the appended claims. The presently disclosed technology is defined by the following claims, with equivalents of the claims to be included therein.

While the presently disclosed technology has been particularly illustrated and described with reference to exemplary embodiments thereof, it will be understood by those of ordinary skill in the art that various changes in form and detail may be made therein without departing from the spirit and scope of the presently disclosed technology as defined by the following claims. The exemplary embodiments should be considered in a descriptive sense and not for purposes of limitation.

What is claimed is:

1. A method of selecting key information, the method being performed by a computing device and comprising:
obtaining source information, which is graph-structured information, and grouping information reflecting the result of clustering the source information; and
selecting one or more pieces of key information of each group g according to the grouping information from nodes n belonging to the group g by using a term frequency-inverse document frequency (TF-IDF)(g, n) value given to each node n of the group g,
wherein the TF-IDF(g, n) value is a value obtained as a result of inputting a node n to a TF-IDF algorithm as a concept corresponding to a term t and inputting a group g to the TF-IDF algorithm as a concept corresponding to a document d.

2. The method of claim 1, wherein the source information is cyber threat intelligence information, each group according to the grouping information comprises nodes related to an infringement incident, each node represents an infringement resource, and an edge between the nodes represents the connection relationship between the infringement resources.

3. The method of claim 1, wherein the selecting of the pieces of key information comprises selecting one or more pieces of key information of each group g according to the grouping information from nodes n and edges e belonging to the group g by using a TF-IDF(g, n) value or a TF-IDF(g, e) value given to each node n and each edge e of the group g,
wherein the TF-IDF(g, e) value is a value obtained as a result of inputting an edge e to a TF-IDF algorithm as a concept corresponding to a term t and inputting a group g to the TF-IDF algorithm as a concept corresponding to a document d.

4. The method of claim 3, wherein an edge e is regarded as belonging to a group g based on all of two nodes connected by the edge e belonging to the group g.

5. The method of claim 3, wherein an edge e is regarded as belonging to a group g based on one of two nodes connected by the edge e belonging to the group g.

6. The method of claim 1, wherein the selecting of the pieces of key information comprises selecting one or more pieces of key information of each group g according to the grouping information from nodes n and partial graphs s belonging to the group g by using a TF-IDF(g, n) value or a TF-IDF(g, s) value given to each node n and each partial graph s of the group g,
wherein the partial graphs s constitute the source information and each are composed of two or more element nodes and an element edge connecting the element nodes, and the TF-IDF(g, s) value is a value obtained as a result of inputting a partial graph s to a TF-IDF algorithm as a concept corresponding to a term t and inputting a group g to the TF-IDF algorithm as a concept corresponding to a document d.

7. The method of claim 6, wherein each of the partial graphs s comprises two element nodes and an element edge connecting the element nodes.

8. The method of claim 6, wherein each of the partial graphs s comprises three element nodes and element edges connecting the element nodes.

9. The method of claim 6, wherein each of the partial graphs s comprises m element nodes and element edges connecting the element nodes, wherein m is a natural number of 2 or more and is a value automatically determined based on data size of the source information.

10. The method of claim 6, wherein the obtaining of the information comprises further obtaining similarity information between nodes of the source information, and the selecting of the pieces of key information comprises adjusting a TF(g, n) value indicating whether each node n is included in each group g by reflecting the similarity information between the nodes n; and generating the TF-IDF(g, n) value by using the adjusted TF(g, n) value.

11. The method of claim 10, wherein the adjusting of the TF(g, n) value comprises adjusting the TF(g, n) value by adding similarity values between node n and another nodes in group g to the existing TF(g, n) value.

12. The method of claim 10, wherein the adjusting of the TF(g, n) value comprises obtaining M1×M2(g, n) as the adjusted TF(g, n) value, wherein a matrix M1 is a two-dimensional (2D) matrix which has nodes disposed as a first axis and groups disposed as a second axis and whose matrix values are TF(g, n) values, and a matrix M2 is a 2D matrix which has nodes disposed as a first axis and nodes disposed as a second axis and whose matrix values are similarity values between the nodes.

13. The method of claim 12, wherein the generating of the TF-IDF(g, n) value by using the adjusted TF(g, n) value comprises generating the TF-IDF(g, n) value by using a DF(n) value, which is obtained as a result of rounding down each adjusted TF(g, n) value and then adding the rounded down TF(g, n) values for all groups, and the adjusted TF(g, n) value.

14. The method of claim 10, wherein the selecting of the pieces of key information comprises:
adjusting a TF(g, s) value indicating whether each partial graph s is included in each group g by using a ratio of the TF(g, n) value after being adjusted and the TF(g, n) value before being adjusted; and
generating the TF-IDF(g, s) value by using the adjusted TF(g, s) value.

15. The method of claim 14, wherein the adjusting of the TF(g, s) value by using the ratio of the TF(g, n) value after being adjusted and the TF(g, n) value before being adjusted comprises increasing a TF(g1, s) value by a maximum rate among rates of increase of TF(g1, n) values of nodes belonging to group g1 through the adjustment.

16. The method of claim 14, wherein the generating of the TF-IDF (g, s) value by using the adjusted TF(g, s) value comprises generating the TF-IDF(g, s) value by using a DF(s) value, which is obtained as a result of rounding down each adjusted TF(g, s) value and then adding the rounded down TF(g, s) values for all groups, and the adjusted TF(g, s) value.

17. A method of selecting key information, the method being performed by a computing device and comprising:
obtaining source information, which is graph-structured information composed of nodes and edges between the nodes, and grouping information reflecting the result of clustering the source information;
selecting one or more pieces of key information of each group g according to the grouping information from nodes n and edges e belonging to the group g by using a TF-IDF(g, n) value given to each node n or a TF-IDF(g, e) value given to each edge e of the group g; and
receiving an information request for a first group among the groups from a client and sending response information, which comprises the key information of the first group, to the client based on the number of elements of the first group exceeding a reference value.

18. An apparatus for selecting key information, the apparatus comprising:
a communication interface;
a memory operatively coupled to the communication interface; and
a processor operatively coupled to the memory, wherein the processor executes a computer program loaded into the memory,
wherein the computer program comprises:
instructions for obtaining source information, which is graph-structured information, and grouping information reflecting the result of clustering the source information;
instructions for selecting one or more pieces of key information of each group g according to the grouping information from nodes n belonging to the group g by using a TF-IDF(g, n) value given to each node n of the group g; and
instructions for receiving an information request for a first group among the groups from a client through the communication interface and sending response information, which comprises the key information of the first group, to the client through the communication interface.
